(19) United States
(12) Patent Application Publication
(10) Pub. No.: US 2017/0084129 A1
(43) Pub. Date: Mar. 23, 2017

(54) Gaming Systems, Electronic Gaming Machines, And Logic Circuitry For Conducting Skill-Based And Hybrid Gaming

(71) Applicant: Bally Gaming, Inc., Las Vegas, NV (US)

(72) Inventors: Anthony J. Baerlocher, Henderson, NV (US); Elizabeth A. Carter, Chicago, IL (US); Jeremy M. Hornik, Chicago, IL (US); Keith M. Kruczynski, Henderson, NV (US); Jeffry L. Nauman, Yorkville, IL (US); Kenneth Shawn Soong, Henderson, NV (US); James W. Vann, Chicago, IL (US)

(21) Appl. No.: 15/273,159

(22) Filed: Sep. 22, 2016

Related U.S. Application Data
(60) Provisional application No. 62/221,882, filed on Sep. 22, 2015.

(51) Int. Cl. G07F 17/32; G07F 17/34

(52) U.S. Cl. CPC G07F 17/3295; G07F 17/3211; G07F 17/3209; G07F 17/3258; G07F 17/3267; G07F 17/34

(57) ABSTRACT

Presented herein are electronic gaming machines, gaming systems, and logic circuitry for executing wagering game applications. A gaming system is disclosed which includes game-logic circuitry and a regulated gaming machine. The gaming machine includes one or more electronic display devices and one or more electronic input devices coupled to a gaming cabinet. The wagering game includes a skill-based game element and a non-skill based game element. The game-logic circuitry: detects, via an electronic input device, a physical item associated with a monetary value that establishes a credit balance; initiates the wagering game in response to a wager input covered by the credit balance; directs an electronic display device to display an outcome of the casino wagering game, the outcome being influenced by the skill-based game element and/or the non-skill based game element; and receives, via an electronic input device, a cashout input that initiates a payout from the credit balance.

### CROSS-REFERENCE To RELATED APPLICATIONS

This application claims the benefit of and priority to U.S. Provisional Patent Application No. 62/221,882 titled “Gaming Systems, Electronic Gaming Machines, And Logic Circuitry For Conducting Skill-Based And Hybrid Gaming,” filed on Sep. 22, 2015, which is incorporated herein by reference in its respective entirety.

### COPYRIGHT

A portion of the disclosure of this patent document contains materials which are subject to copyright protection. The copyright owner has no objection to the facsimile reproduction by anyone of the patent disclosure, as it appears in the Patent Office records or patent files, but otherwise reserves all copyright rights whatsoever.

### TECHNICAL FIELD

The present disclosure relates generally to electronic gaming machines, casino gaming systems, gaming networks, and logic circuitry for executing wagering game application modules. More particularly, aspects of this disclosure relate to skill-based wagering games and hybrid wagering games with both skill-based and non-skill-based components.

### BACKGROUND

Electronic gaming machines (EGM), such as slot machines, video poker machines, and the like, have become a cornerstone of the gaming industry. Generally, the popularity of such machines with players is dependent on the likelihood (or perceived likelihood) of winning money at the machine and the entertainment value of the machine relative to other available gaming options. Where the available gaming options include a number of competing machines, and the expectation of winning at each machine is roughly the same (or believed to be the same), players are typically attracted to the most engaging, entertaining and exciting machines. Shrewd operators consequently strive to employ technologically advanced gaming devices that can provide the most engaging, entertaining and exciting game features and enhancements because such devices attract frequent play and, hence, increase profitability to the operator. As such, gaming manufacturers continuously endeavor to develop advanced gaming machines with improved gaming logic and innovative electronic hardware that will engender frequent play and player loyalty through enhanced entertainment and engaging game play.

Gaming machines are highly regulated to guarantee fairness, to assure the machines continue to operate properly, and to ensure the gaming hardware is free from criminal influence and exploitation. In many cases, gaming machines are designed to dispense very valuable awards, including large sums of money. Accordingly, access to and control over such gaming machines is carefully controlled. Some jurisdictions, for example, require extra personnel, such as gaming control supervisory staff, be notified in advance and be in attendance during routine maintenance of a machine. Additionally, many gaming machines are manufactured with dedicated hardware and software architectures that differ significantly from those of general-purpose computers (PCs) to ensure compliance with local gaming regulations. For example, conventional electronic gaming machines are fabricated with stringent security and fault tolerance hardware and software components. Additionally, gaming machines generally operate in harsher environments as compared with PCs, and thus are designed with special purpose cabinets and internal hardware to ameliorate deleterious environmental effects.

A significant technical challenge is to improve the operation of gaming apparatuses and games played thereon, including the manner in which they leverage an underlying random element generator, by making them yield a negative return on investment in the long run (via a high quantity and/or frequency of player/apparatus interactions), and yet random and volatile enough to make players feel they can win sums of money in the short run. Striking the right balance between yield versus randomness and volatility to create a feeling of luck involves addressing many technical problems, some of which can be at odds with one another. This “luck” factor is what appeals to core players and encourages prolonged and frequent player participation. As the industry matures, the creativity and ingenuity required to improve such operation of gaming apparatus and games grows accordingly.

Most electronically implemented wagering games are non-skill-based games—“games of chance”—employing game-logic circuitry to generate randomly determined game outcomes. Skill-based games, on the other hand, typically offer a greater degree of player involvement and interaction than their non-skill-based counterparts. Unlike non-skill-based wagering games where the game outcome is predominantly, if not solely, based on chance (e.g., a random selection stemming from a randomly generated number), skill-based games are games in which the outcome of the game is predominantly, if not solely, determined by a player's physical skill (e.g., reflex or dexterity) or mental skill (e.g., logical reasoning, strategic thinking, trivia knowledge). Many games of skill do have an element of chance; however, the player's skill is the dominant factor in determining the game's outcomes. In the same vein, many games of chance have elements of player interaction, control and skill; however, such player interaction, control and skill are not dominant factors in determining the game's outcomes. Hybrid skill-and-chance games incorporate both skill-based and non-skill-based gaming features. A hybrid game can be typified, for example, as a game in which a combination of player skill and random chance affects outcomes of the game as determined over a predetermined period of play (e.g., a million game outcomes).

Conventional wagering games are typically designed to minimize elements of skill because many gaming regulations prohibit giving certain players an advantage or “edge” over other players. Skill-based games often end up with some disadvantaged players who, for example, use less than the most optimal strategy, do not make the best decisions, or are at a physical disadvantage. Recognizing the potential benefits of skill-based and hybrid wagering games, with the attendant need to regulate the parameters of skill-based game features to ensure appropriate player disclosure and fairness for all players, some jurisdictions are codifying gaming regulations for skill-based and hybrid wagering games. Accordingly, there is a need for wagering games that include one or more skill-based components and comport with all corresponding gaming commission regulations. Such new skill-based features will further enhance the player experience, perpetuate player loyalty, and thus increase game play and profitability to operators and manufacturers.

### SUMMARY

Aspects of the present disclosure are directed to hybrid skill-and-chance wagering games, pure skill-based wagering games, and wagering games that can vary between pure skill and pure chance wagering games. A “pure chance game” includes wagering games where each game outcome is 100% random and player interaction, including changing the wager amount or other tangential inputs, cannot alter any of the game outcomes. Antithetically, a “pure skill game” includes wagering games where each game outcome is 100% dependent on player skill. Skill games are predominately influenced by individual player ability, whether it be physical, mental, intuitional, or other skill. Hybrid skill-and-chance games (“hybrid game”) include elements of skill and elements of chance such that, for example, somewhere between approximately 50.1% and approximately 99.9% of the game outcomes are randomly determined.

It is desirable, for at least some implementations, that a wagering game, when evaluated as a whole over a predetermined period of play, including all skill-based and non-skill-based elements, achieve a minimum predetermined payback percentage. In general, the minimum predetermined payback percentage cannot be established through a single game outcome, a single cycle of game outcomes, a single gaming session, a single feature within a game (e.g., a bonus game), or a subset of gaming features (e.g., a series of progressive jackpot games). Rather, a regulated gaming device must pay out a mathematically demonstrable percentage of all amounts wagered, which must not be less than, for example, 75 percent for each wager available. These games help to present more robust themes and provide more interactive gaming, including competitions of e-sports, military combat, racing, and contests of knowledge or strategy.

Some implementations allow for a range of payback percentages based, for example, on game attributes that the operator can adjust, including the game's levels of skill and chance. For at least some implementations, player skill can increase the frequency, size and/or probability of game payouts, e.g., so long as the potential for such increases is made known to players in advance and payback percentage is maintained. At least some of the disclosed game configurations are designed to include persistent gaming features and rollover prize pools. Also disclosed are gaming platforms that permit multi-player games and network-based games that exploit a broad range of popular video games or a broad range of popular arcade games. In this regard, an electronic gaming machine can be networked to engage in transactions with sports books and to leverage interactive gaming. Social networking capabilities can be leveraged to “personalize” the player's experience when playing electronic gaming machines and “socialize” the player experience. Some implementations allow the games to function in tournament, pooled, community, peer-to-peer, group and/or individual player formats. It is desirable, for at least some embodiments, that once a game of skill or a hybrid game is initiated by a player on a gaming device, no aspect or function of the gaming device may be altered during play based on skill to make an event more or less likely to occur.

Aspects of the present disclosure are directed to networked and standalone casino gaming systems for conducting wagering games. For instance, disclosed is a gaming system that includes game-logic circuitry and a regulated gaming machine that is primarily dedicated to conducting a casino wagering game. The casino wagering game includes a skill-based game element and a non-skill based game element. These game elements may be parts of a single game feature or, alternatively, may be implemented in separate game features. The gaming machine includes, for example, one or more electronic display devices and one or more electronic input devices that are coupled to a gaming cabinet. The game-logic circuitry is configured to: detect, via at least one of the one or more electronic input devices, a physical item that is associated with a monetary value that establishes a credit balance; initiate the casino wagering game in response to an input that is indicative of a wager covered by the credit balance; direct at least one of the one or more electronic display devices to display an outcome of the casino wagering game, the outcome being influenced by the skill-based game element, the non-skill based game element, or both; and receive, via at least one of the one or more electronic input devices, a cashout input that initiates a payout from the credit balance.

Other aspects of the present disclosure are directed to electronic gaming machines (EGM), such as electro-mechanical and electronic casino slot machines, for conducting wagering games. For instance, disclosed herein is a regulated gaming machine that is primarily dedicated to conducting a casino wagering game. The gaming machine includes, for example, an electronic display device, one or more electronic input devices, and game-logic circuitry. The game-logic circuitry is configured to: detect, via at least one of the electronic input devices, a physical item that is associated with a monetary value that establishes a credit balance, the credit balance changing based on play of the casino wagering game; initiate the casino wagering game in response to an input that is indicative of a wager covered by the credit balance, the casino wagering game including a skill-based game element and a non-skill based game element; direct the electronic display device to display an outcome of the casino wagering game, the outcome being influenced by the skill-based game element, the non-skill based game element, or both; and receive, via at least one of the one or more electronic input devices, a cashout input that initiates a payout from the credit balance.

Additional aspects of this disclosure are directed to computer-implemented methods, programmable game-logic circuitry, and game content engines for conducting wagering games. In an example, disclosed herein is a method of operating a gaming system that includes game-logic circuitry and a regulated electronic gaming machine. The electronic gaming machine, which is primarily dedicated to conducting a casino wagering game, comprises an electronic display device and one or more electronic input devices mounted on a gaming cabinet. The method comprises: detecting, via at least one of the one or more electronic input devices, a physical item associated with a monetary value that establishes a credit balance, the credit balance changing based on play of the casino wagering game; initiating the casino wagering game in response to an input indicative of a wager covered by the credit balance, the casino wagering game including a skill-based game element and a non-skill based game element; displaying, via the electronic display device, an outcome of the casino wagering game, the outcome being influenced by the skill-based game element, the non-skill based game element, or both; and receiving, via at least one of the one or more electronic input devices, a cashout input that initiates a payout from the credit balance.

The above summary does not represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present invention when taken in connection with the accompanying drawings and the appended claims.

### BRIEF DESCRIPTION OF THE DRAWINGS

FIG. 1 is a perspective-view illustration of a representative free-standing electronic gaming machine (EGM) according to aspects of the present disclosure.

FIG. 2 is a schematic diagram of a representative electronic gaming machine (EGM) in a networked gaming system according to aspects of the present disclosure.

FIG. 3 is a screen shot of a game screen of a representative non-skill-based wagering game conducted on a regulated casino gaming device according to aspects of the present disclosure.

FIG. 4 is a screen shot of a game screen of a representative skill-based wagering game conducted on a regulated casino gaming device according to aspects of the present disclosure.

FIG. 5A is a screen shot of screen shot of a game screen of a representative hybrid wagering game with a skill-based game feature and a non-skill-based game feature in accordance with aspects of the present disclosure.

FIG. 5B is a screen shot of a game screen of another representative hybrid wagering game with a skill-based game feature and a non-skill-based game feature in accordance with aspects of the present disclosure.

FIG. 6 is a screen shot of a game screen of a representative hybrid wagering game with skill-influenced pseudo-random outcomes according to aspects of the present disclosure.

FIG. 7 is a flowchart for an algorithm that corresponds to instructions executed by game-logic circuitry of a gaming system or an electronic gaming machine in accord with aspects of the present disclosure.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, combinations and subcombinations, and alternatives falling within the spirit and scope of the disclosure as defined by the appended claims.

### DETAILED DESCRIPTION OF ILLUSTRATED EXAMPLES

This disclosure is susceptible of embodiment in many different forms. There are shown in the drawings, and will herein be described in detail, representative embodiments with the understanding that the present disclosure is to be considered as an exemplification of the principles of the present invention and is not intended to limit the broad aspects of the disclosure to the embodiments illustrated. To that extent, elements and limitations that are disclosed, for example, in the Abstract, Summary and Detailed Description sections, but not explicitly set forth in the claims, should not be incorporated into the claims, singly or collectively, by implication, inference or otherwise. For purposes of the present detailed description, unless specifically disclaimed or logically prohibited: the singular includes the plural and vice versa; and the words “including” or “comprising” or “having” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

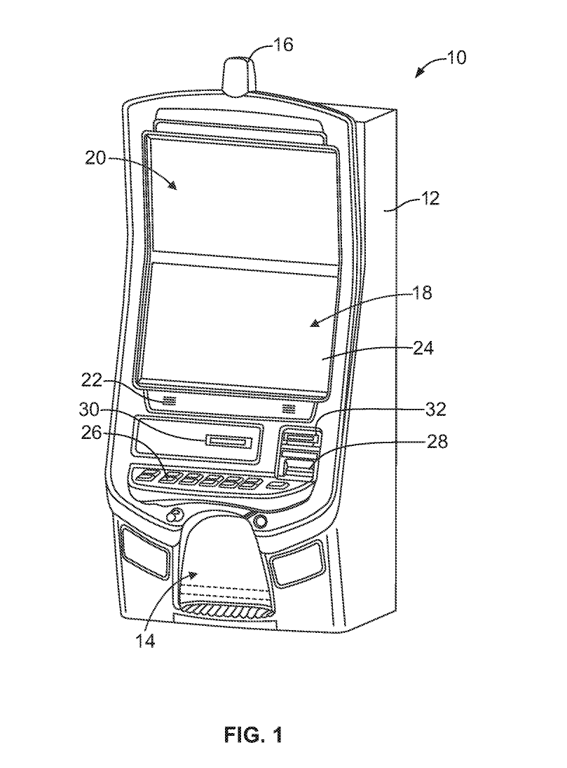

Referring to the drawings, wherein like reference numerals refer to like features throughout the several views, there is shown in FIG. 1 an electronic gaming machine or “EGM” 10 similar to those operated in gaming establishments, such as casinos. With regard to the present disclosure, the gaming machine 10 may be any type of gaming terminal or machine (“gaming terminal” and “gaming machine” and “gaming device” being used interchangeably in this disclosure), and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, all of which are incorporated herein by reference in their respective entireties and for all purposes.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 can also form an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

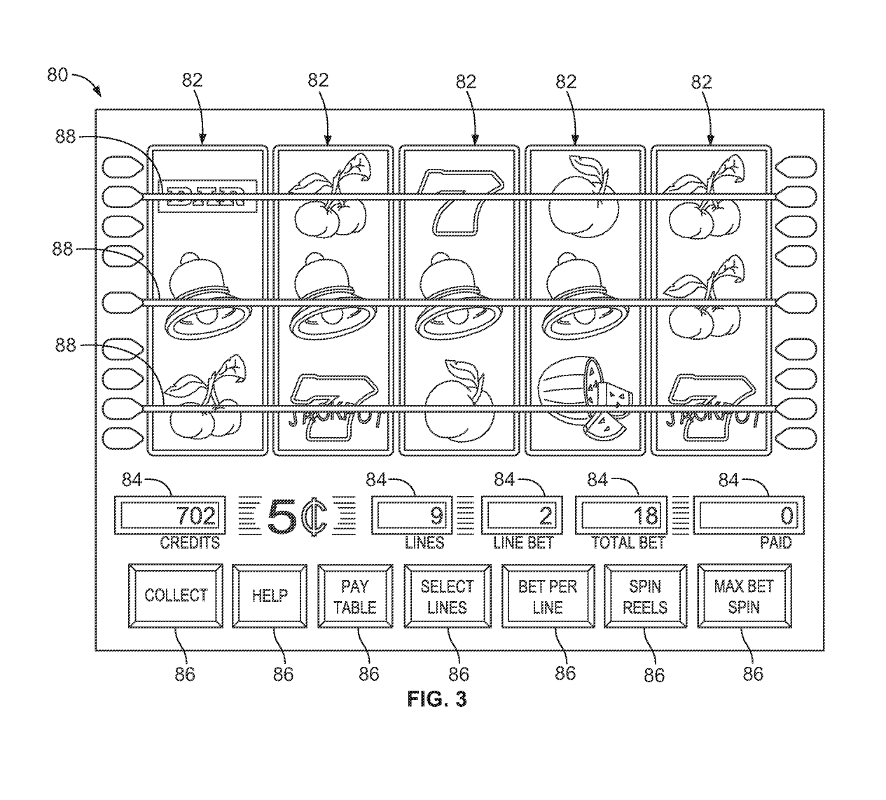

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

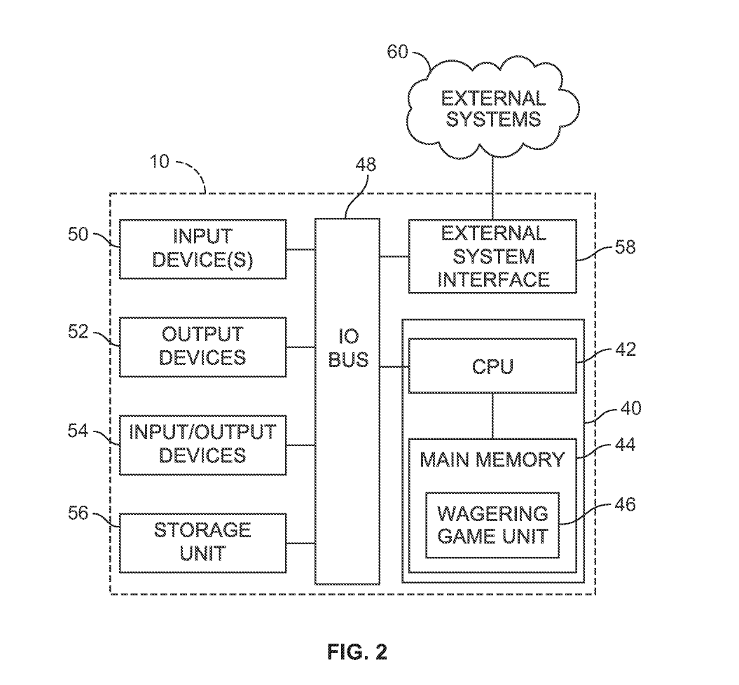

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 of a game of chance that can be adapted to be displayed on the primary display 18 and/or the secondary display 20 of gaming machine 10. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

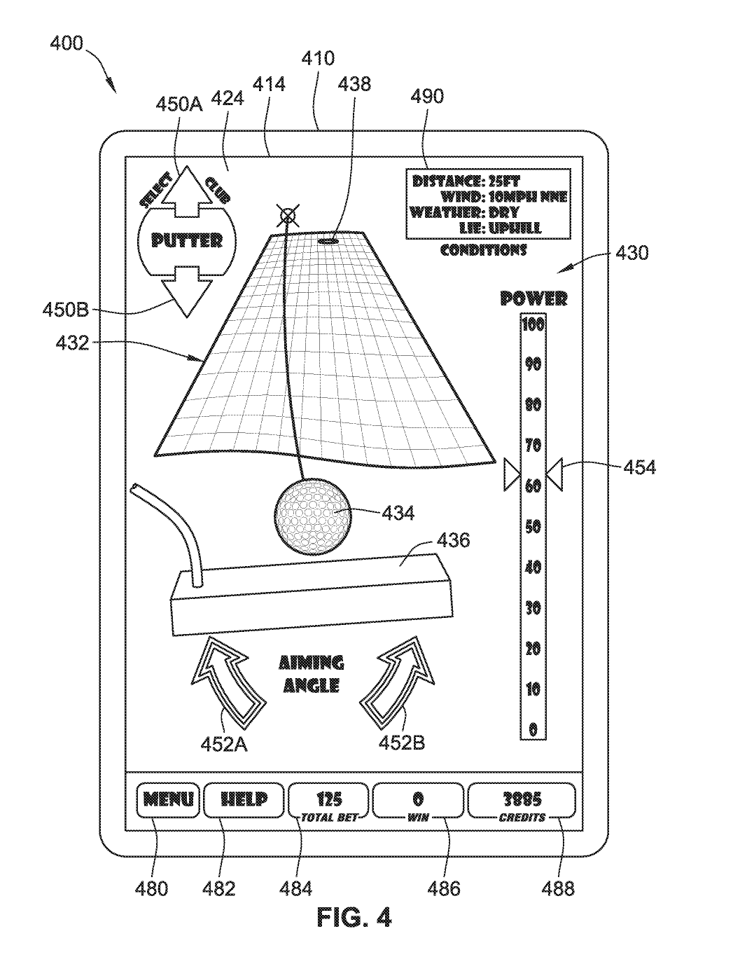

For purposes of comparison to the non-skill-based wagering game 80 of FIG. 3, there is shown in FIG. 4 an example of a player interactive skill-based game 430 for wagering on a virtual round of golf or a select portion of a golf game. A primary display 414 of a gaming device or terminal 410, which may be part of an exemplary gaming system 400, is shown in FIG. 4 displaying an interactive wagering game 430, which may be a base game, a bonus game, a tournament game, a community game, a peer-to-peer game, or other applicable gaming format. Although differing in appearance, the gaming terminal 410 can be similar in function, operation and connectivity to the other gaming terminals discussed herein and, thus, can include any of the corresponding options, features and alternatives described with respect thereto (and vice versa). For instance, gaming terminal 410 may be an electronic gaming terminal configured to conduct one or more traditional casino wagering games video casino game, such as keno, poker, slots, blackjack, roulette, etc., in addition to or in conjunction with the skill-based wagering game 430. As another example, gaming terminal 410 is configured as an electronic gaming machine (EGM) which, by way of comparison to conventional arcade gaming terminals for playing video games, allows for monetary wagers to be placed on, and monetary awards to be won from, outcomes of the wagering game 430.

The display device 414 displays or otherwise visually depicts a wagering game 430, which in this example is a video-simulated golf putting game. Game mode graphics include, for instance, a golf course green 432 having a virtual ball 434 struck by a virtual club 436 towards a hole 438. Display device 414 of FIG. 4 includes, for example, a touchscreen overlay 424 with a plurality of player-selectable soft keys to generate a corresponding plurality of game control signals, wagering selections, and display or viewing control signals fed to a microprocessor, such as central processing unit (CPU) 42 of game-logic circuitry 40 of FIG. 2. For example, primary display 414 presents display features that may include a MENU button 480, a HELP button 482, a TOTAL BET meter 484, a WIN meter 486, a CREDITS meter 488, and a CONDITIONS key 490. MENU button 480 can be pressed and activated (e.g., through an overlying touchscreen) by a player desiring to access control menus, e.g., to change a theme of the wagering game or to change the type of the wagering game (e.g., to video poker, keno, slots, etc.). The HELP button 482 can be pressed and activated to access help screens, informational menus, etc. Additionally, TOTAL BET meter 484 displays to a player the current size of his/her wager (in credits). The gaming machine 410 may be set for a $0.25, $0.50, $1.00 bet or other denomination such that the selected wager is a multiple of the set denomination (e.g., a 125 credit wager on a $0.25 machine is equivalent to a $31.25 wager). The WIN meter 486 displays to the player the amount of the total win (if any) from the most recent play of the wagering game 430. The CREDITS meter 488 displays to the player the total amount of credits (if any) remaining and available to the player for play of the wagering game 430. CONDITIONS key 490 provides the player with information related to their current playing conditions, such as the distance from their ball to the hole, wind velocity, the weather conditions, and ball lie. Fewer, additional, or alternative display features may be included for presenting information and/or options to a player.

What demarcates between a skill-based wagering game, such as the skill game 430 of FIG. 4, and a non-skill-based wagering game, such as the game of chance 80 of FIG. 3, is the amount that player skill influences the overall outcome of the game. In contrast to a non-skill-based game 80, where the game outcome is predominantly, if not solely, based on chance (e.g., as described above), the outcome or outcomes of a skill-based game 430 is/are predominantly, if not solely, determined by a player's physical skill (e.g., strength, reflex, dexterity, and other motor skills) and/or mental skill (e.g., logical reasoning, strategic thinking, knowledge, and other intellectual abilities). While the game of skill 430 does have elements of chance, for example, due to natural aspects of the environment (e.g., hole length, fairway and green layout, hazard positioning, sun positioning, wind speed, air temperature, grass length, etc.), a randomizing device (e.g., for determining crosswind characteristics, weather, air density, etc.), or guessing due to incomplete information (e.g., obstructed views, club affect, ball idiosyncrasies, etc.), the player's skill is the dominant factor in determining the game's outcomes. A skill element can include anything a player can influence or manipulate to vary the game outcome, where one player can be better or worse at that skill element than another player.

In addition to the basic display features described above that present game information and allow the player to make non-skill related selections, including wagers, touchscreen 424 also provides soft keys for making skill-based selections. By way of non-limiting example, the skill-based selection soft keys comprise SELECT CLUB selection arrows 450A and 450B, AIMING ANGLE selection arrows 452A and 452B, and a club POWER control meter 454. As can be garnered from their names, SELECT CLUB selection arrows 450A and 450B allow the player to choose from an assortment of selectable woods and selectable irons for their next golf shot. A graphic showing the virtual clubs available for selection may also be included on the video display during game play mode. To this regard, AIMING ANGLE selection arrows 452A and 452B allow the player to choose the direction of the club head for the next golf shot. POWER control meter 454 utilizes a touch-sensitive oscillating element that, when selected, sets the club power and/or speed. It should be readily appreciated that the video-simulated golf putting game 430 may include greater or fewer or alternative skill-based soft keys, including those dedicated to other skill elements that allow the player to influence the game's outcome(s). Moreover, other input mechanisms, in addition or as an alternative to the touchscreen 424, may be utilized to receive player inputs, such as a track ball, a trackpad, a mouse, a motion-sensing game controller, gesture recognition sensors and software, etc. It is through these various input devices, and exploiting player skill, that the outcome of the wagering game 430 is determined.

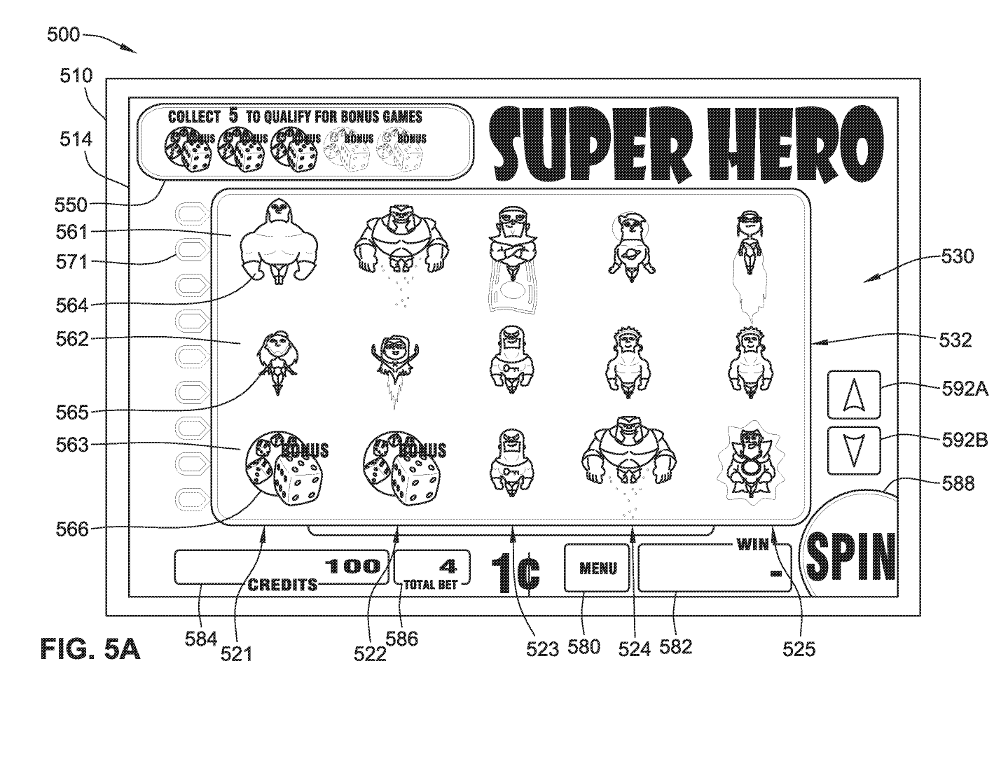

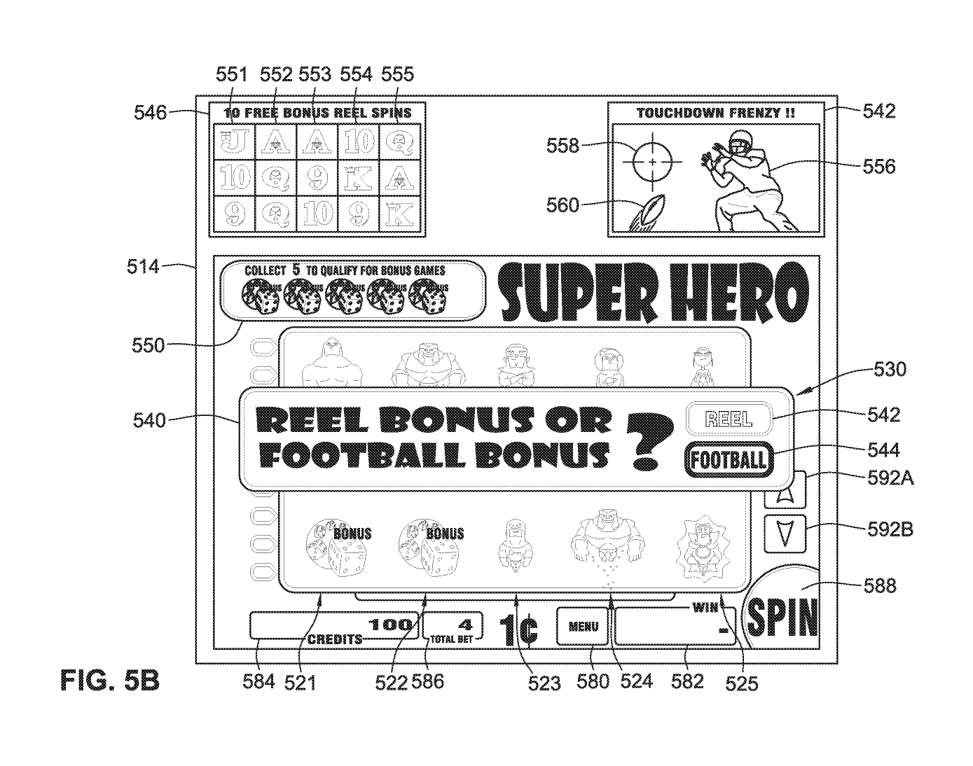

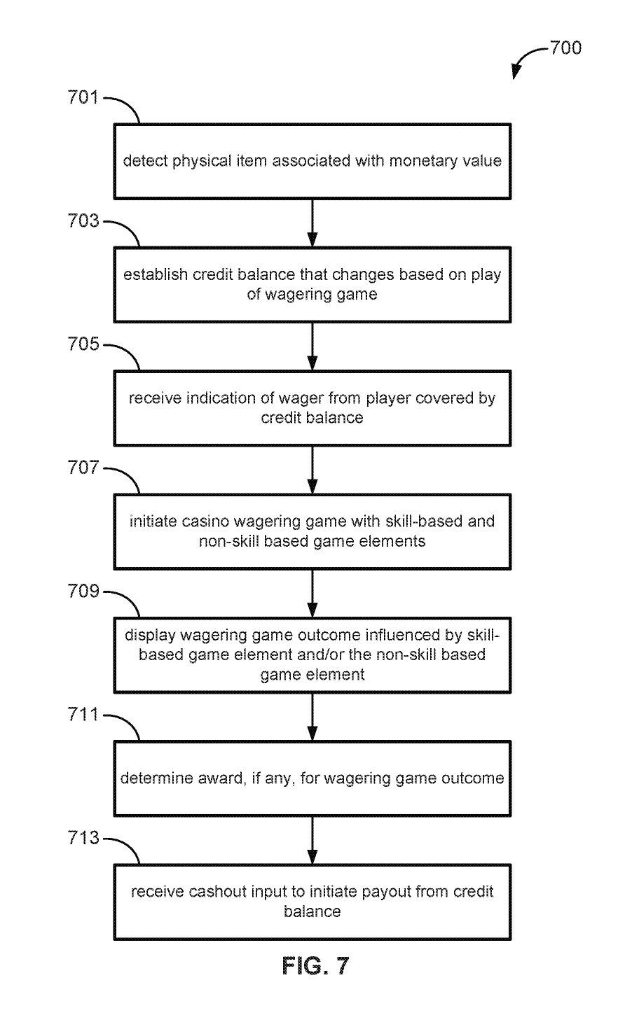

Having provided examples of chance wagering games (FIG. 3) and skill wagering games (FIG. 4), FIGS. 5A and 5B are screen shots of a game screen from an exemplary hybrid wagering game 530 in accordance with aspects of the present disclosure. Similar to FIGS. 3 and 4, a primary display 514 of a gaming device or terminal 510, which may be part of an exemplary gaming system 500, is shown in FIGS. 5A and 5B. The gaming system 500 of FIG. 5A may be similarly configured to the gaming system shown in FIG. 2, while the gaming terminal 510 can be similar in function, operation and connectivity to the gaming terminals shown in FIGS. 1-4. In addition to the hybrid wagering game 530, the primary display device 514 of the gaming terminal 510 can be configured to display other wagering games, such as those described above with respect to FIGS. 1-4 or those described below with respect to FIGS. 7-8, for example. Although numerous aspects of the wagering game 530 are all shown displayed on a single display device, these aspects are not so limited and can be displayed in any combination on any number of display devices unless otherwise expressly prohibited.

Display device 514 displays or otherwise visually depicts a hybrid wagering game 530, which includes the slot game shown in FIG. 5A. The slot game 530 includes a plurality of symbol-bearing reels, designated generally as 521-525, each having a plurality of distinct symbol positions (collectively represented by three symbol positions 561-563) and bearing a number of symbols (collectively represented by three symbols 564-566). The symbols may include any variety of graphical symbols, emblems, elements, or representations, including symbols that are associated with one or more themes of the gaming terminal 510 and gaming system 500 (e.g., a Super Duper Heroes theme). A subset of the symbols on reels 521-525 populate array positions of an array 532, which in this embodiment is a 3×5 matrix (i.e., three rows by five columns) of symbols. The reels 521-525 are varied (e.g., spun and stopped) to reveal combinations of symbols in the array 532, which represent randomly selected outcomes of the wagering game 530, that are evaluated for winning symbol combinations. Winning combinations of symbols landing, for example, on activated paylines (e.g., those paylines for which a wager has been received), cause awards to be paid in accordance with one or more pay tables associated with the wagering game 530.

Within the scope of this disclosure, the base-game portion of the wagering game 530 illustrated in FIG. 5A can include greater or fewer than five symbol-bearing reels (simulated, mechanical, or otherwise) and, in some embodiments, greater or fewer symbol positions than those shown in the Figure. In this regard, the randomly selected outcomes may comprise greater or fewer than 15 symbols, and may take on a variety of different forms having greater or fewer rows and/or columns. The matrix may even comprise other non-rectangular forms or arrangements of symbols. Moreover, the randomly selected outcomes of the wagering game 530 may be varied from the representation provided in FIG. 5A. Likewise, the Super Duper Heroes game theme is purely illustrative and non-limiting in nature.

The primary display 514 further includes certain display features for providing information and options to a player. For example, the display 514 features may include a MENU button 580, a WIN meter 582, a CREDITS meter 584, and a TOTAL BET meter 586. The MENU button 580 can be pressed and activated (e.g., through an overlying touch screen) by a player desiring to access other control menus, preferences, help screens, informational menus, etc. For example, the player can change a theme of the wagering game 530 via the MENU button 580, or change the type of the wagering game (e.g., to video poker, keno, etc.). The WIN meter 582 displays to the player the amount of the total win (if any) from the most recent play of the wagering game 530. The CREDITS meter 584 displays to the player the total amount of credits (if any) remaining and available to the player for play of the wagering game 530. The TOTAL BET meter 586 displays to a player the current size of his/her wager (in credits). Once a number of paylines are selected and a wager is placed, a SPIN button 588 can be pressed or otherwise activated by a player to effectuate rotation of the reels 521-525. In an optional configuration, selection of a SPIN button will effectuate rotation of the reels 521-525 without requiring prior selection of a wager and/or a number of paylines (e.g., a default wager and a default number of payline(s) are automatically chosen upon selection of the SPIN button 588). Fewer, additional, or alternative display features may be included for presenting information and/or options to a player. Other features may include, in some non-limiting examples, one or more bet change buttons 592A and 592B that permit a player to incrementally increase and/or decrease the size of his/her wager.

The wagering game 530 is shown in FIG. 5A after play of a base game segment is initiated, for example, by the player providing a wager (e.g., responsive to an input via at least one input device), and thereafter pressing a spin button or pulling a spin lever. The monetary wager, which is typically a selected number of credits, is deducted from the available credits, e.g., the 100 credits displayed via the CREDITS meter 584 in FIG. 5A. The monetary wager that is in play (e.g., 4 credits in FIG. 5A) can be displayed via the TOTAL BET meter 586. The reels 521-525 may then be varied (e.g., spun and stopped); the reels 521-525 continue to spin until they are stopped to reveal in the symbol array 532 symbols which represent a randomly selected outcome of the wagering game 530. The wagering-game outcome is, according to some aspects, randomly determined from a plurality of potential wagering-game outcomes. As indicated above, each outcome is evaluated for winning symbol combinations to determine if the displayed outcome has one or more awards associated therewith.

After a game initiating “first” wager is received from a player to play the wagering game 530, and play is initiated, an outcome of the base-game portion of the wagering game 530 is randomly selected and visually represented by 15 symbols arranged on the primary display device 514 in the 3×5 array 532. The base-game outcome of FIG. 5A includes a “start-bonus” or “bonus-game-triggering” outcome. In the illustrated example, a hybrid bonus game is initiated when the player collects a predetermined number of BONUS symbols 566 during play of the base-game portion of the wagering game 530. A bonus symbol bank 550 on the display 514 shows the number of BONUS symbols 566 that have already been collected by the player; in the illustrated example, the player has already collected three BONUS symbols 566. In the most recent base-game outcome of the wagering game 530, the first and second reels 521 and 522, respectively, each includes a BONUS symbol 566 in the third row of the array 532. Thus, the player has now collected a requisite five BONUS symbols 566 to trigger a hybrid bonus game feature. According to the illustrated embodiment, entering into a bonus-game portion of the wagering game 530 is provided in response to a triggering event in the base-game outcome of the wagering game 530. It is within the scope and spirit of the present disclosure to employ alternative mechanisms for triggering a bonus game feature. Optionally, entering into the bonus game and attendant game features discussed herein may not require a triggering event.

In some embodiments, a player may be required to meet certain eligibility requirements to qualify for entry into the skill-based and non-skill-based hybrid bonus games and game features. The eligibility may be based on a number of factors, including acquisition of certain game assets (e.g., a key), reaching certain game milestones (e.g., completing a threshold level in a bonus game), exceeding a certain level of wagering activity, being a member of a certain gaming establishment group (e.g., casino player's club), and the like. Some embodiments may require the player to submit additional credits (“second wager” or “side wager”), on top of the original “first” wager received to initiate the wagering game, to qualify for entry into the skill-based and non-skill-based bonus games and game features. Some configurations can allow players to use virtual currency (e.g., Facebook® credits) to qualify for entry. As opposed to submitting an additional wager to qualify for entry into the skill-based and non-skill-based bonus games, characteristics of the wagering game can be modified to offset any additional winning opportunities garnered by the skill-based and non-skill-based bonus games and game features.

Continuing with the above example wherein a bonus game has been triggered during play of the base game, the player can be provided with various options: the player can elect to initiate and play in a skill-based bonus game feature, the player can elect to initiate and play in a non-skill-based bonus game feature, or both. Alternative configurations may allow this selection to be made prior to or during the spinning and stopping of the reels 521-525. With the five BONUS symbols 566 displayed in the bonus symbol bank 550 of FIG. 5A, the player may be asked, e.g., via a popup window 540 of FIG. 5B, whether to play the REEL BONUS OR FOOTBALL BONUS? in the hybrid skill-and-chance gaming feature. As seen in FIG. 5A, the player has elected to initiate and play in a skill-based game feature by selecting the FOOTBALL bonus game soft key 544; the player did not select the REEL bonus game button 542. Optional variations may forego a visual or audible prompt; configurations can allow or require a player to make a selection prior to or during each, every, or only selected plays of the wagering game 530. In alternative implementations, the selection may be omitted, automated and/or randomized.

In the example illustrated in FIG. 5B, the non-skill-based bonus game feature is a “game of chance,” which is represented herein by a free-spin bonus game 546, the outcomes of which are each based predominantly, if not solely, on a randomized determination. The free-spin bonus game 546 is a slot game that may be similar in function and operation to the base-game portion of the wagering game 530 of FIG. 5A, employing numerous symbol-bearing bonus reels 551-555 that are varied (e.g., spun and stopped) to display randomly selected symbols at respective positions of a symbol array. The player can be awarded an award based on an evaluation of each outcome—i.e., each displayed arrangement of symbols. The free-spin bonus game 546 may conclude after completion of a predetermined, randomly determined, and/or accumulated number of free spins (e.g., 10 free spins in FIG. 5B). Alternatively, play of the non-skill-based game feature can continue until play of the skill-based game feature, described below, is completed.

By way of contrast to the non-skill-based bonus game feature, the skill-based bonus game feature is a type of game in which a player must utilize strategy, knowledge, physical skill, dexterity, and/or other types of abilities to manipulate, organize, select, and/or in any other way control game play elements to accomplish winning game outcomes. The skill-based game feature of FIG. 5B is a “game of skill,” which is represented herein by an American football video game 548 in which the outcomes are based predominantly, if not solely, on player skill. The football bonus game 548 requires the player to use hand-eye coordination, as well as their reflexive capabilities, to attempt to complete passes to a receiver in a virtual football game. More specifically, as a number of virtual receivers 556 are displayed running across a virtual football field, the player, who acts as the team's quarterback, uses one or more input devices (e.g., a mouse, joystick, or touchscreen) to align a target 558 with the receiver 556, and then “throw” a virtual football 560 to the receiver 556. Different types of pass completions can have a different award value associated therewith: a short completion for less than ten yards awards five (5) credits; a first-down completion awards ten (10) credits; a long completion of 25 yards or more awards forty (40) credits; and a touchdown pass awards one hundred (100) credits. Football game 548 may conclude after the player attempts a predetermined, randomly determined, and/or accumulated number of throws (e.g., 10 throws in FIG. 5). Alternatively, play of the skill-based game feature can continue until play of the non-skill-based game feature is completed.

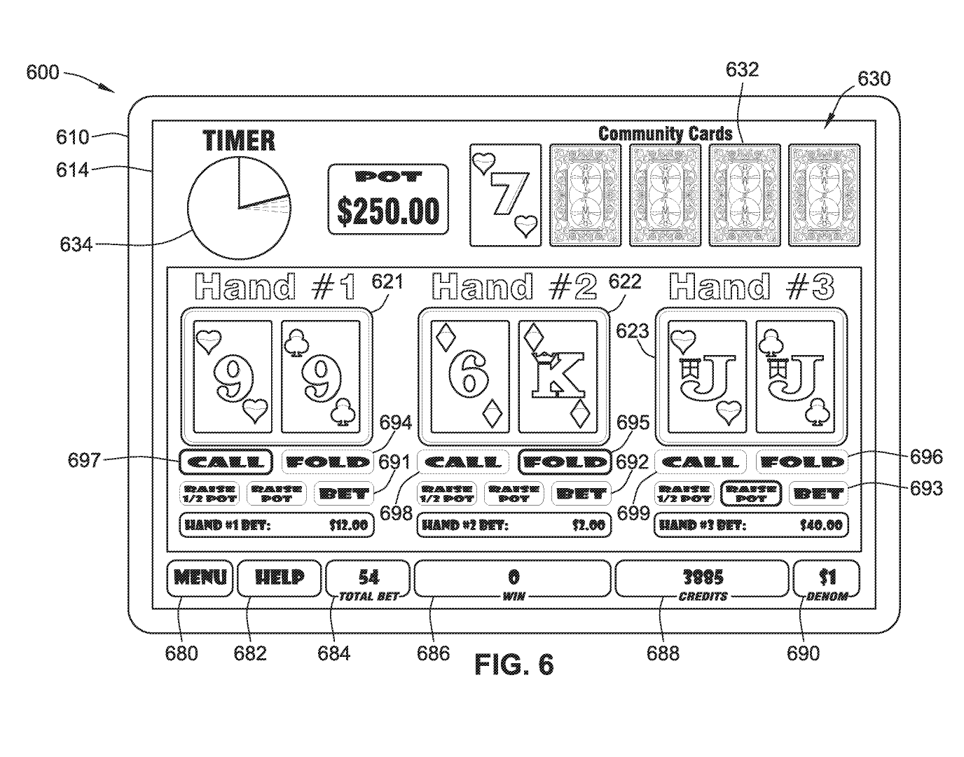

FIG. 6 is a screen shot of a game screen of another representative hybrid wagering game 630 in accordance with aspects of the disclosed concepts. By way of comparison to the wagering game 530 of FIGS. 5A and 5B, which incorporates a hybrid bonus game scheme with a non-skill-based bonus game segment 546 that is played concurrently with yet separately from a skill-based bonus game segment 548 such that each segment generates distinct outcomes, each outcome of hybrid wagering game 630 of FIG. 6 is congruently affected by player skill and random chance. A primary display 614 of a gaming device 610 that is part of a gaming system 600 is shown in FIG. 6 displaying an interactive video poker game 630, which is implemented in a “Texas Hold'em” poker format and may be a base game, a bonus game, a tournament game, a community game, a peer-to-peer game, or other applicable gaming format. It should be recognized, however, that the strategic card game presented in FIG. 6 may comprise other forms of poker, such as “Five Card Draw”, “Omaha Hi”, “Seven Card Stud”, etc., as well as other card games, such as black jack, gin, mah-jongg, baccarat, and known variations thereof, without departing from the scope of the present disclosure. The poker game can be played with a single, standard 52-card deck (i.e., Ace through King of four different suits). One or more cards—e.g., sevens, Jokers, “one-eyed jacks,” “suicide kings,” etc.—may be designated “wild” or designated with another special characteristic. Further, the poker game may be played with additional predefined “special” card(s) (e.g., a “Go Fish!” card) for triggering a special feature (e.g., a “Go Fish!” bonus feature).

During a particular game play, multiple hands 621-623 are dealt to a single player with cards drawn from the same deck or, alternatively, from multiple decks. In a single deck implementation, after a card is drawn or dealt from the deck into the poker hand, that card is “used up” and cannot appear again until at least the next game play or until the deck is virtually “shuffled” by the game engine. The deck may thereafter be replenished and randomly shuffled prior to every poker hand or, alternatively, after cycling through the entire deck or stack of decks. System memory includes a data structure for storing data representing each card of the deck; game-logic circuitry then randomly selects cards for each poker hand from the data structure, and controls one or more displays to display the cards. FIG. 6 displays the wagering game 630 prior to presentment of a game outcome, namely before all of the community cards 632 are dealt to complete each hand. The image includes two “hole” cards per hand, five community cards, game-session meters, buttons selectable by a player, and a pay table. Game-session meters displayed by the primary display 614 include, for example, a MENU button 680, a HELP button 682, a TOTAL BET meter 684, a WIN meter 686, a CREDITS meter 688, and a select DENOM button 690 for a player to change the denomination of the machine 610. Other fields and meters may be incorporated into the display 614, including those described above.

During normal play of the wagering game 630, a player may be required to make a first “ante” wager for all dealt hands or, optionally, a respective “ante” wager for each hand to enter the game, e.g., against a dealer's hand or to achieve winning hand combinations dictated in a paytable. The ante wager(s) may be deducted automatically by the game engine or submitted via BET buttons 691-693. Two randomly determined “hole” cards are then virtually “dealt” for each hand 621-623. Players can be provided with play options to check, bet, raise and/or fold after each deal: betting, etc., may occur prior to the flop (dealing of the first three “flop” cards of the community cards), “on the flop” (after the flop cards are dealt), “on the turn” (after a fourth “turn” card of the community cards is dealt), and “on the river” (after a fifth “river” card of the community cards is dealt). After viewing the hole cards, for example, a player may have an opportunity to make a play bet, e.g., via BET soft key buttons 691-693, match or “call” a competing player's previous bet, e.g., via CALL soft key buttons 697-699, or optionally to discontinue a hand, e.g., via FOLD soft key button 694-696. Once all five community cards 632 are dealt, and all bets are placed or hands folded, a five-card poker hand outcome is obtained for each hand 621-623 by matching cards from the community with the hole cards. An optional timer 634 can be implemented to restrict the amount of time a player has to make one or more or all game play decisions and, concomitantly, increase (or decrease) the skill level required to play the wagering game 630.

Video poker wagering game 630 is a hybrid skill-and-chance wagering game because a substantial percentage (e.g., over 50%) of each game outcome is dependent upon player skill, such as making the right decision on which bets to place, which cards to hold or fold, reading other player's playing habits, etc., and a substantial percentage (e.g., over 40%) of each game outcome is dependent upon chance, including the random shuffling and dealing of the playing cards. It may be desirable, for at least some implementations, that the poker wagering game 630, which mimics a live casino game, similar to video roulette, craps, and blackjack games, must maintain fair odds for all players, irrespective of player skill. While the implements of the wagering game, such as the playing cards, can be manipulated or varied (e.g., as described above) so long as any such manipulation is fully disclosed and maintained for all players. In the same vein, it is desirable in at least some implementations that any idiosyncratic skill-based elements and variations to any well know skill-based elements that affect the classification of a wagering game must be disclosed to players.

With reference now to the flow chart of FIG. 7, an improved method for conducting a regulated, hybrid wagering game on a gaming machine and/or a gaming system primarily dedicated to conducting wagering games, such as those shown in FIGS. 1-6, for example, is generally described at 700 in accordance with aspects of the present disclosure. FIG. 7 can be representative of an algorithm that corresponds to instructions that can be stored, for example, in main memory 44 of FIG. 2, and executed, for example, by the CPU 42 and/or external system(s) 60 of FIG. 2 to perform any or all of the above or below described functions associated with the disclosed concepts. The method 700 will be described with reference to the various aspects and features shown in FIGS. 1-6 of the drawings; such reference is being provided purely by way of explanation and clarification.

Method 700 begins, for example, at block 701 with detecting, e.g., via one of the electronic input devices 28 and 30 of FIG. 1 or input device(s) 50 of FIG. 2, a physical item that is associated with a monetary value. This physical item may comprise a casino player club card associated with a player's personal credit account. Once detected, the method 700 then establishes a credit balance for the player at block 703. As described above, the credit balance, which may be displayed in a corresponding credit meter of an EGM's display device, increases and decreases as a result of wagers lost and awards won during game play. In this regard, block 705 requires receiving an indication of a wager from a player. This may comprise a physical input from the player being received via an input device, such as touch screen 24, bill/ticket acceptor 28, card reader/writer 30, etc. The electronic player-input device(s) then transforms the player input(s) to electronic data signal(s) indicative of the player input(s), and transmits the data signal(s) to CPU 42 of game-logic circuitry 40.

Responsive to the electronic data signal or signals received from the one or more electronic player-input devices at block 705, the method 700 initiates a hybrid skill-and-chance wagering game at block 707. This hybrid skill-and-chance casino wagering game may comprise the hybrid bonus game scheme presented in FIGS. 5A and 5B, the hybrid card game scheme presented in FIG. 6, or any other wagering game described herein that includes both a skill-based game element and a non-skill based game element. The skill-based game element may be implemented as a distinct skill-based gaming feature that includes outcomes which are based solely or predominantly on player skill. Likewise, the non-skill-based game element may be implemented as a distinct non-skill-based gaming feature, which includes outcomes that are based solely or predominantly on randomized determinations conducted by game-logic circuitry. For some implementations, it is desirable that a “first” payout percentage associated with the non-skill-based gaming feature be configured to offset a “second” payout percentage of the skill- based gaming feature such that the wagering game pays out a mathematically demonstrable predetermined minimum payback percentage. In alternative configurations, the casino wagering game includes one or more outcomes based on both player skill related to skill-based game elements and randomized determinations related to non-skill-based game elements.

The method 700 may further comprise, e.g., during the initiation stage presented in block 707, commencing a normalizing protocol that is operable to modify one or more parameters of the casino wagering game to ensure that the casino wagering game pays out a mathematically demonstrable predetermined minimum payback percentage. The normalizing protocol may include modifying the degree to which the skill-based game element or the non-skill-based element affects one or more outcomes of the casino wagering game. Optionally, the normalizing protocol modifies one or more award values of one or more outcomes of the casino wagering game affected by the skill-based game element. As yet another option, the normalizing protocol modifies a percentage of future wagers contributed to an award pool or progressive jackpot awarded in response to a randomly determined outcome in the casino wagering game. Alternatively, the normalizing protocol modifies a number of free plays of a bonus game of chance (or a bonus game of skill) awarded to a player in response to the player successfully completing or failing to complete a skill-based game feature (or non-skill-based game feature). As another option, the player may be presented with the opportunity to select a difficulty level of a skill-based segment or skill-based portions of a game (e.g., increase or decrease the difficulty level); the game engine responsively modifies the overall pay structure of the game to match the player-selected change. Each of the foregoing options is described in further detail below.

One or more electronic display devices display to the player one or more outcomes of the wagering game, each of which is influenced by elements of skill, elements of chance, or both, as indicated at block 709. For configurations where the skill-based game element is implemented as a skill-based gaming feature, successful completion of the skill-based gaming feature can result in a progressive jackpot or award pool being awarded to the player. In instances where the skill-based game element is implemented as a game of skill and the non-skill-based game element is implemented as a game of chance, successful completion of the skill-based gaming feature can result in one or more free plays of the non-skill-based gaming feature being awarded to the player (and vice versa). The percentage of the outcome of the casino wagering game affected by the skill-based game element can be determined, for example, based on historical game result data of multiple players playing the casino wagering game. The game-logic circuitry can be configured to vary one or more parameters of the casino wagering game to increase or decrease the level of difficulty associated with the skill-based game element(s). Moreover, the game-logic circuitry can be configured to modify one or more parameters of the skill-based game element in response to a second input indicative of a second wager covered by the credit balance. At block 711, the method 700 determines if there are any awards associated with each game outcome and, if so, such awards can then be conferred upon the player. Block 713 indicates receipt of a cashout input from the player (e.g., via COLLECT touchscreen button 86 in FIG. 3) that initiates a payout from the credit balance.

In some embodiments, the method 700 includes at least those steps enumerated above. It is also within the scope and spirit of the present disclosure to omit steps, include additional steps, and/or modify the order presented above. It should be further noted that the method 700 represents a single play of a wagering game. However, it is expected that the method 700 be applied in a systematic and repetitive manner.

Aspects of this disclosure can be implemented, in some embodiments, through a computer-executable program of instructions, such as program modules, generally referred to as software applications or application programs executed by a computer. The software can include, in non-limiting examples, routines, programs, objects, components, and data structures that perform particular tasks or implement particular abstract data types. The software can form an interface to allow a computer to react according to a source of input. The software can also cooperate with other code segments to initiate a variety of tasks in response to data received in conjunction with the source of the received data. The software can be stored on any of a variety of memory media, such as CD-ROM, magnetic disk, bubble memory, and semiconductor memory (e.g., various types of RAM or ROM).

Moreover, aspects of the present disclosure can be practiced with a variety of computer-system and computer-network configurations, including hand-held devices, multiprocessor systems, microprocessor-based or programmable-consumer electronics, minicomputers, mainframe computers, and the like. In addition, aspects of the present disclosure can be practiced in distributed-computing environments where tasks are performed by remote-processing devices that are linked through a communications network. In a distributed-computing environment, program modules can be located in both local and remote computer-storage media including memory storage devices. Aspects of the present disclosure can therefore, be implemented in connection with various hardware, software or a combination thereof, in a computer system or other processing system.

It should be noted that the algorithms illustrated and discussed herein as having various modules or blocks or steps that perform particular functions and interact with one another are provided purely for the sake of illustration and explanation. It should be understood that these modules are merely segregated based on their function for the sake of description and represent computer hardware and/or executable software code which can be stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

The following exemplary features, options and configurations are not intended to represent every embodiment or every aspect of the present disclosure. Nevertheless, each of the disclosed systems, methods, devices, game formats, etc., including those illustrated in the figures, may comprise any of the features, options, and alternatives described herein above and below with respect to the other embodiments, singly and in any combination, unless explicitly disclaimed or logically prohibited.

In accordance with at least some of the disclosed embodiments, skill-based and hybrid wagering games, irrespective of design layout and content, are configured to exhibit a mathematically demonstrable predetermined minimum payback percentage (e.g., pay out at least approximately 75% of all wagers made) over a predetermined period of play (e.g., a million game outcomes). While it is generally considered acceptable for one player of a skill or hybrid game to perform over 100% payback consistently or, conversely, for one player to perform at or around below 0% payback, the game configuration can be required to average out to a minimum payback percentage. For example, one way to achieve a minimum payback percentage in a skill or hybrid game is to deposit a percentage of each wager into a progressive jackpot or other wager pool and, once a player or set of players accomplish a goal or complete a task associated with a particular progressive/pool, the accumulated monetary value of that progressive/pool is awarded to the player(s). In a simple example, the skill-based wagering game 430 can be implemented in a tournament style format where a large number of participants, for example, 1000 players submit an entry fee of $10 per player to compete to see who can shoot the lowest score in an 18-hole standard rules round of golf (e.g., as promulgated by the United States Golf Association (USGA®)). If the minimum payback percentage established, for example, by local gaming regulations is 90%, then $9.00 of each $10 wager is deposited into an award pool for the duration of the tournament, whereas the remainder of $1.00 is surrendered to the house for hosting the tournament. Upon completion of the tournament, the award pool may be awarded in its entirety to a single player with the lowest score or, alternatively, may be divided up into prize ranks and awarded to a group of players, e.g., with the first, second and third lowest scores.

Another exemplar way for achieving a minimum payback percentage includes skill-based game features with awards comprising free plays of a game of chance. For instance, the skill game can be implemented as a dart throwing game, which can employ any standardized darts format (e.g., X01 (pronounced oh-one) darts, Cricket darts, Around the Clock darts, etc.), or other throwing sport. Some implementations require an entrance fee or “buy in” to throw a predetermined number of darts. Optionally, the buy in entitles the player to one free play of a chance game, which may comprise awarding the player a lottery ticket, a jackpot drawing ticket, or a scratch-off (“scratchcard” or “instant lottery”) ticket. During game play, the player is awarded one or more additional plays/tickets for achieving certain predefined tasks. If a player hits: (1) a bullseye with a dart, they are awarded, for example, five plays/tickets; (2) a triple zone with a dart, they are awarded, for example, three plays/tickets; (3) a double zone with a dart, they are awarded, for example, two plays/tickets; and, (4) a single zone with a dart, they are awarded, for example, a single play/ticket. Additional plays/tickets can be awarded for special achievements, such as scoring a “ton 80”—throwing three consecutive darts in the triple-20 zone—or a “triple bull”—throwing three consecutive darts in the inner bull of the bullseye. For implementations which award jackpot drawing tickets, a portion of each player's buy in can be added to a jackpot pool or players can compete for a casino funded jackpot. At a preselected or random point during game play, a drawing is held and the player with the winning drawing ticket number is awarded the jackpot. Optional configurations may include selecting multiple tickets to win awards from the jackpot.

In the above example, player skill is a dominant factor because it increases/decreases the likelihood of winning awards/jackpots by increasing/decreasing the number of plays/tickets accumulated by the player during play of the darts game. Nevertheless, overall payback percentage is controlled through the payback in the ticket-based game of chance. While a player may receive a scratch-off ticket or other free play, for example, that prize does not guarantee the player will win a monetary award—they are subject to the preset odds of winning the game of chance. This game format, where free plays in a game of chance are prizes for a game of skill, can be considered a converse counterpart to the hybrid bonus game scheme presented in FIGS. 5A and 5B, where free plays in a game of skill are prizes for a game of chance. It is also possible to split the player wagers among different games of chance, e.g., with 40% going to the award pool(s) for the drawing tickets, 50% going to the house to fund the award(s) for the scratch-off tickets, and 20% going to the house to fund the jackpot(s) won with the lottery tickets. Notably, if the foregoing wagering game configuration eliminates the darts game feature and, thus, any corresponding skill-based elements, the wagering game is a (pure) game of chance. Conversely, if the wagering game configuration eliminates the ticket award feature and, thus, any corresponding non-skill-based elements, the wagering game is a (pure) game of skill. By shifting the percentage of coin divided between these two segments, game developers and engineers can shift the designation of the now hybrid game between pure skill and pure chance.

In accord with other aspects of the disclosed concepts, a feature of a wagering game may comprise a prize table with a plurality of jackpots, where each jackpot is assigned a respective value (or initial value) such that the assigned values increase from one jackpot to the next. In addition, each jackpot is assigned a respective winning ticket (entry) quantity such that the assigned winning ticket (entry) quantities increase from one jackpot to the next. By way of non-limiting example, the prize table may include: Jackpot 1 with a first jackpot value ($100) and a first winning ticket quantity (1); Jackpot 2 with a second jackpot value ($200) and a second winning ticket quantity (2); Jackpot 3 with a third jackpot value ($500) and a third winning ticket quantity (5); and Jackpot 4 with a fourth jackpot value ($1000) and a fourth winning ticket quantity (10). During play of a base game portion or bonus game portion of the wagering game, which may comprise or consist of a game of chance, players are awarded tickets (or entries) into a jackpot drawing. At preselected or randomly selected times, a drawing is commenced and a predetermined number of tickets (or entries) of those awarded to players are drawn to identify one or more winners of the enumerated jackpots. It is desirable, in at least some implementations, that plural tickets (e.g., 20 entries) are drawn with each commenced drawing. In this example, to achieve one of the higher level jackpots—Jackpots 2-5—a single player must have collected the requisite winning ticket (entry) quantity. For instance, if 20 tickets (or entries) are drawn, player 1 must have collected 10 of the drawn tickets to win Jackpot 4, collected 5 of the drawn tickets to win Jackpot 3, or collected 2 of the drawn tickets to win Jackpot 3. With this configuration, a single player can win all of the available jackpots (e.g., if player 1 collected 18 of the drawn tickets) or twenty players can each have won a single jackpot, namely Jackpot 1.

In order to determine which specific gaming regulations and/or what corresponding payback requirements apply to a particular wagering game, it may be necessary to characterize or otherwise determine if that wagering game as is a game of skill, a game of chance, or a hybrid skill-and-chance game. By way of example, video poker and other strategic wagering games with a finite set of outcomes can be established as a hybrid game by: (1) identifying the corresponding rule set (e.g., Jacks-or-Better poker versus Bonus Five Card poker versus Texas Hold' em poker); (2) identifying the paytable layout, including the types of available winning outcomes, designated award for each winning hand, volatility of award distribution, etc.; and (3) identifying the best possible strategy for someone with the best skill—if somebody played e.g., 1,000,000 hands perfectly—and the worst possible strategy for someone with no skill. In so doing, one can measure and establish a maxim skill level and a minimum skill level. From these measurements of maximum and minimum skill, it is also possible to determine a range of payouts which, in turn, helps to establish an estimated payback percentage. Determining the best possible strategy or strategies can include mathematically simulating the expected outcomes, e.g., with fuzzy logic schema or heuristic mathematics, or by creating computer-generated virtual players and simulating a representative data population of expected game play. It is also possible to a representative population of players, e.g., with one or more sample sets, and record historical game result data of multiple players playing the casino wagering game.

One manner of shifting the designation of a wagering game between pure skill and pure chance is by manipulating the parameters of the game to increase skill (reduce chance) or increase chance (and reduce skill) during game play. With respect to the interactive skill-based golf game 430 of FIG. 4, for example, the percentage of influence of skill on any particular outcome can be reduced by the game-logic circuitry randomly varying: (1) wind speed and direction, (2) weather conditions, (3) air density, (4) size of golf hazards/green/hole, etc. Another option may include randomly introducing an unknown time delay into an input device. When a player presses the touch-sensitive oscillating element of the POWER control meter 454 of FIG. 4, for example, the game-logic circuity institutes a randomly determined 0.01 second delay before the meter is activated. Another option would be to introduce randomly selected idiosyncrasies into elements of the game, such as a warped golf club, a defective golf ball, a scarred or otherwise damaged green, etc. As per the aforementioned darts game, the game-logic circuitry can randomly vary certain aspects of the skill elements, including the target's size, location, and/or distance, the weight, size and/or accuracy of each dart, etc. These changes can be visible or invisible to the player. Other options would be to randomly change the rules of the game and/or randomly add or subtract features that affect skill (with proper notice to the player).

It is desirable, for at least some embodiments, to strictly prohibit reflexive algorithms that alter aspects or functions of a gaming device or a hybrid/skill wagering game during game play in response to player skill to make an event more or less likely to occur. In some instances, prescribed reflexive changes are acceptable so long as they are clearly and unambiguously conveyed to the player and applied consistently irrespective of player skill. Optional configurations do not allow dynamic alterations to any function of any element or feature in the game as a direct response to achieving or attempting to achieve a desired payback percentage.

An optional gaming feature for any of the disclosed hybrid and skill based wagering games is to provide a player with an option to practice a skill-based gaming element. One example includes a skill-based bonus game feature where the player is allowed to attempt a half-court basketball shot for a large award (e.g., $50,000). A similar variant would be an attempt at a hole-in-one shot in the virtual golf game of FIG. 4. To the unskilled, unpracticed player, this feat may seem daunting and impossible. Recognizing the level of skill required to complete such a task, which may dissuade players from playing the underlying wagering game, the game engine can provide a player with the option to take one or more practice shots. This option may be in response to submission of a secondary wager, completion of a predetermined number of plays of the base game, a predetermined number of failed attempts, a predetermined turnover in wagers, a random determination, or any other known triggering event. By providing the player with one or more practice shots, the wagering game actually assists in increasing player skill for that particular skill-based gaming feature.

Another concept for offsetting low skill level includes measuring or otherwise determining each player's skill level, and then applying an appropriate offset or “handicap” to even the playing field with more skilled players. For some implementations, the amount of skill necessary for a particular skill or hybrid game, or the size of a handicap provided to a particular player to offset a lack of skill, can be based on a size of a player's wager. In our half-court basketball shot example, the player handicap can include: (1) making the basketball rim a predetermined degree wider; (2) providing the player with one or more additional shots; (3) moving the player a predetermined distance closer to the rim, etc. Instead of submitting a secondary wager, the player can choose to take a reduced prize in exchange for one of the foregoing selections. Another option to offset skill level would be to provide lower skilled players with a free game or default “consolation” prize.

As yet another option to offset low skill level in a hybrid or skill game would be to allow a player to selectively change one or more parameters of a hybrid or skill wagering game to thereby decrease the level of skill necessary to achieve a winning game outcome. Referring once again to the interactive skill-based golf game 430 of FIG. 4, for example, a player can submit a secondary wager or accumulate certain game assets or randomly or systematically be provided with the option to: (1) reduce or eliminate a cross wind; (2) move the player's ball to a better lie; (3) move or eliminate a hazard; (4) eliminate a penalty stroke, etc. In a memory match wagering game example where the player is provided with a field of cards and tasked with flipping two cards at a time to match similar cards within a predetermined number of attempts, (e.g., 25 or 50 pair selections), the player can be provided with the option of: (1) removing a select number of pairs that need to be matched; (2) increasing the number of attempts to complete the memory match game; (3) revealing the counterpart card for one or more picks, etc. In our half-court basketball shot example, the player can be provided with the option to: (1) make the basketball rim a bit wider; (2) make the basketball a bit smaller; (3) allow the player to move closer to the rim, (4) increase the number of attempts to make the shot, etc.

In another example, a player can be provided with the option to choose a volatility for one or more subsequent plays of the wagering game based on their level of skill. For instance, if a player is performing poorly during a skill-based or hybrid game feature and, thus, is winning few or not winning any prizes, that player can be provided with the option select a game element that decreases volatility—the probability of achieving a prize is increased; however, all prize values are concomitantly reduced. Conversely, if a player is performing extremely well during a skill-based or hybrid game feature and, thus, is winning many prizes, that player can be provided with the option to select a game element that increases volatility—all prize values are increased, but the corresponding probabilities of achieving said prizes is concomitantly reduced.

In yet another example, a skill-level offset can be achieved through a strategic skill-based bonus game, which is achieved through play of an underlying game of chance, that provides the player with multiple chances to solve a single puzzle or otherwise complete a single task. This can include, for example, the memory match card game described above that is triggered during play of an underlying base slot game, such as the slot game 80 illustrated in FIG. 3. For instance, a player may achieve a bonus-game-triggering symbol combination for a free play of the memory match game; a large concentration board with an array of numerous cards is displayed to the player with all of the cards briefly shown face up; the cards are then flipped face down, and the player is challenged with remembering where the matching cards for each award is positioned. If the player fails to identify any of the matching pairs and, thus, fails to win any of the bonus game awards, yet continues to the play the underlying slot game, the next instance when the memory match bonus game is triggered presents to the player the same arrangement of cards so that the player has another opportunity to learn where the matching cards are positioned. This feature assists players with low skill levels and also encourages players to continue to play the underlying base game by increasing the likelihood of achieving a winning position with each subsequent triggering of the skill-based bonus game. For some embodiments, the bonus game would reset and provide a new arrangement of cards after a predetermined number of failed attempts to achieve a winning position.

Another concept that can be incorporated into any of the disclosed skill and hybrid wagering games is introducing schema into the game format to compel desired playing behaviors. With reference again to the strategic card wagering game presented in FIG. 6, the game scheme can be modified such that multiple players are “sitting” at a virtual “table” and competing to build the best poker hand from a playing field of cards. In this example, a prize is awarded to the player with the highest hand after all players “grab” five cards, for example, within an allotted time. Prizes for this implementation come from an award pot that is funded, for example, with a predetermined payback percentage (e.g., 75%) of the total amount wagered from all competing players. The award pot itself is then broken down, for example, to pay a first portion to the best overall hand, a second portion if the best hand is a straight flush or a royal flush, a third portion if the best hand is a standard straight of a standard flush, and so on. When using a single, standard deck of cards, the game engine can calculate the odds of achieving each of these hands. The paytable is set such that the portion of the pot assigned to each winning hand is greater than the likelihood of achieving that hand. In so doing, players are incentivized to, not just beat the other competing players, but to try to achieve the highest hand.

Any of the disclosed hybrid and skill wagering games may incorporate one or more identifiers that affect game play. As used herein, an “identifier” can be defined to include any specific and verifiable fact concerning a player or group of players which is based upon objective criteria relating to the player or group of players. Examples of identifiers include, without limitation: (a) the frequency, value, or extent of predefined commercial activity by a player or group of players; (b) the subscription to or enrollment in particular services, such as a player club account; (c) the use of a particular technology concurrent with the play of a gaming device; (d) a determined skill level of a player or group of players; (e) the skill of the player/group relative to the skill of any other player/group participating in the same game; (f) the degree of skill required by the game; or (g) any combination of (a) to (f). For at least some embodiments, the game engine employs an identifier or combination of identifiers to determine: (1) which skill or hybrid games will be presented to or available for selection by a player; (2) which paytables or prize amounts are made available to a player; (3) which special features within a game will be presented to or available for selection by a player; (4) which house rules apply to a particular skill or hybrid game, etc.

As indicated above, any of the disclosed wagering game configurations can be implemented in sessions. A “session” can be defined to include a series of games on a gaming device commenced after a player commits a wager and ending at the time of a final game outcome for that series of games. A gaming session can also include a period of time commencing when a player initiates a first play of a game on a gaming device by committing a wager, and ending at the time of a final game outcome of a final play for that game. It is desirable, for at least some embodiments, that the rules and format of a game cannot be changed throughout a session, from inception to completion. While it is acceptable, for example, to progressively increase the level of difficulty of a wagering game within a single gaming session, e.g., as the player progresses to higher levels, the rules of the game do not change and the format of the game remains the same. It may be acceptable, for some implementations, to change the game parameters between wagers in a single session so long as a clear and unambiguous description of that change is presented to the player before the player makes a wager. In some persistent state skill and hybrid configurations, a player can be provided with the option of ending a session at a particular level of play, and subsequently initiating a new wager and pick up at the same level.

It was also noted above that any of the disclosed hybrid games and skill games can be implemented in tournament, pooled, community, peer-to-peer, and/or group player formats For instance, at randomly selected times, an assortment of items (e.g., floating balloons) appears on one or more of the display devices of the electronic gaming machine. This same assortment of items is presented to every player at the gaming bank or otherwise participating in the group game. Players race to tap the items, e.g., through inputs on their overlaying touchscreen, and receive award credits. Once an item is tapped on any one screen, it disappears on all screens, and is awarded to the first player to tap that item. Optionally, items may be identified by colors or other indicators so players have an idea of which are the most/least valuable. This hybrid bonus game scheme may include multiple players, peer-to-peer, teams, groups against the machine, cooperative gameplay, competitive gameplay,

An example of a wagering game configuration that includes a skill-based feature that depends on a players reflexes comprises an object that appears on a display device at random times during game play. This object has 100% of its value at the moment it appears and, as time passes, the object gradually loses value (e.g., it is at 90% value after one second, 80% value after two seconds, 50% value after three seconds, and so on). Players must react to the objects appearance as quickly as possible in order to earn the maximum prize. One drawback with many conventional skill-based games is they are slow and take a relatively long time as compared to a single play of a conventional wagering game (e.g., a spin of slot reels, a hand of blackjack, etc.); there is an inherent advantage to skill and hybrid games designed to encourage people to play faster.

An example of a wagering game configuration that includes a skill-based feature with a trivia tournament requires players to interface with a casino-wide trivia game on their mobile devices or other electronic gaming machine. Each player may be required to pay an entry fee in order to participate in a round of trivia. Competing players answer the same set of questions, each with a short amount of time allowed to answer (e.g., to prevent players from attempting to search for answers on the internet). Players are paid based on how well they answer the questions: players may be paid for as many questions they get right within X minutes Players may be paid on how many they answer right before getting one wrong.

The present disclosure is not limited to the precise construction and compositions disclosed herein. Each of these embodiments, including any and all modifications, changes, and variations apparent from the foregoing description, is contemplated as falling within the scope of the invention as defined in the appended claims. Moreover, the present concepts expressly include any and all combinations and subcombinations of the preceding elements and aspects.

1-20. (canceled)

21. A gaming system, comprising:
a regulated gaming machine primarily dedicated to playing at least one casino wagering game, the gaming machine including an electronic display device and one or more electronic input devices; and
game-logic circuitry configured to:
detect, via at least one of the one or more electronic input devices, a physical item associated with a monetary value that establishes a credit balance,
initiate the casino wagering game in response to an input indicative of a wager covered by the credit balance, the casino wagering game including a skill-based game and a non-skill based game,
in response to receiving input for playing a skill-based task of the skill-based game, achieve a skill-based outcome,
based on the skill-based outcome, award a plurality of free plays of the non-skill based game, and
receive, via at least one of the one or more electronic input devices, a cashout input that initiates a payout from the credit balance.

22. The gaming system of claim 21, wherein the skill-based task includes a plurality of different skill-based outcomes, each of the plurality of different skill-based outcomes being associated with a respective number of the plurality of free plays.

23. The gaming system of claim 21, wherein the game-logic circuitry is further configured to receive an entrance fee for performing the skill-based task.

24. The gaming system of claim 23, wherein, in response to receiving the entrance fee, the game-logic circuitry is further configured to award at least one free play of the non-skill based game.

25. The gaming system of claim 24, wherein the free play is selected from a group consisting of a lottery ticket, a scratch-off ticket, and a jackpot drawing ticket.

26. The gaming system of claim 25, wherein a jackpot award associated with the jackpot drawing ticket is funded by a gaming establishment or by a portion of the entrance fee.

27. The gaming system of claim 26, wherein the jackpot award is awarded based on collecting a requisite number of winning jackpot drawing tickets.

28. The gaming system of claim 21, further including a random element generator configured to generate one or more random elements, an outcome of the non-skill based game being randomly selected based, at least in part, on the one or more random elements.

29. The gaming system of claim 28, wherein the random element generator and the game-logic circuitry reside within a gaming cabinet of the gaming machine.

30. A regulated gaming machine primarily dedicated to playing at least one casino wagering game, comprising:
an electronic display device;
one or more electronic input devices; and
game-logic circuitry configured to:
detect, via at least one of the one or more electronic input devices, a physical item associated with a monetary value that establishes a credit balance,
initiate the casino wagering game in response to an input indicative of a wager covered by the credit balance, the casino wagering game including a skill-based game and a non-skill based game,
receive, via at least one of the one or more electronic input devices, input for playing a skill-based task of the skill-based game,
display on the electronic display device a skill-based outcome of the skill-based task,
based on the skill-based outcome, award a plurality of free plays of the non-skill based game, and
receive, via at least one of the one or more electronic input devices, a cashout input that initiates a payout from the credit balance.

31. The gaming machine of claim 30, wherein the skill-based task includes a plurality of different skill-based outcomes, each of the plurality of different skill-based outcomes being associated with a respective number of the plurality of free plays.

32. The gaming machine of claim 30, wherein the game-logic circuitry is further configured to receive an entrance fee for performing the skill-based task.

33. The gaming machine of claim 30, wherein, in response to receiving the entrance fee, the game-logic circuitry is further configured to award at least one free play of the non-skill based game.

34. A method of operating a gaming system, the gaming system including game-logic circuitry and a regulated gaming machine, the gaming machine being primarily dedicated to playing at least one casino wagering game, the gaming machine including an electronic display device and one or more electronic input devices, the method comprising:
detecting, via at least one of the one or more electronic input devices, a physical item associated with a monetary value that establishes a credit balance;
initiating the casino wagering game in response to an input indicative of a wager covered by the credit balance, the casino wagering game including a skill-based game and a non-skill based game;
in response to receiving, via at least one of the one or more electronic input devices, input for playing a skill-based task of the skill-based game, achieve a skill-based outcome;
based on the skill-based outcome, awarding a plurality of free plays of the non-skill based game, and
receiving, via at least one of the one or more electronic input devices, a cashout input that initiates a payout from the credit balance.

35. The method of claim 34, wherein the skill-based task includes a plurality of different skill-based outcomes, each of the plurality of different skill-based outcomes being associated with a respective number of the plurality of free plays.

36. The method of claim 34, further comprising receiving an entrance fee for performing the skill-based task.

37. The method of claim 36, further comprising, in response to receiving the entrance fee, awarding at least one free play of the non-skill based game.

38. The method of claim 37, wherein the free play is selected from a group consisting of a lottery ticket, a scratch-off ticket, and a jackpot drawing ticket.

39. The method of claim 38, further comprising funding a jackpot award associated with the jackpot drawing ticket by a gaming establishment or by a portion of the entrance fee.

40. The method of claim 39, further comprising awarding the jackpot award based on collecting a requisite number of winning jackpot drawing tickets.
